(19) United States
(12) Patent Application Publication
(10) Pub. No.: US 2022/0401948 A1
(43) Pub. Date: Dec. 22, 2022

(54) FLUID HANDLING DEVICE

(71) Applicant: Enplas Corporation, Saitama (JP)

(72) Inventor: Koichi ONO, Saitama (JP)

(73) Assignee: Enplas Corporation, Saitama (JP)

(21) Appl. No.: 17/777,033

(22) PCT Filed: Nov. 9, 2020
(86) PCT No.: PCT/JP2020/041739

§ 371 Date: May 15, 2022

(30) Foreign Application Priority Data
Nov. 19, 2019 (JP) 2019-208874

(51) Int. Cl. B01L 3/00

(52) U.S. Cl. CPC B01L 3/502; B01L 2200/027; B01L 2300/123; B01L 2200/0689

(57) ABSTRACT

This invention addresses the problem of providing a fluid handling device that can be reliably and easily connected to various devices, can supply a desired fluid to various devices, and can receive fluid from various devices. The fluid handling device that addresses this problem comprises: a first device having a flow path for allowing a fluid to flow therethrough and an opening for connecting the flow path and the outside; and a tube having a first end that is inserted into the opening. The first device further comprises a support part that fixes the tube such that the central axis of a second end of the tube is at an angle in relation to the central axis of the first end of the tube.

### TECHNICAL FIELD

The present invention relates to a fluid handling device.

### BACKGROUND ART

In recent years, a fluid handling device having a fine channel has been used in order to conduct an analysis, reaction, and the like of a trace amount of substance such as a protein or a nucleic acid with high accuracy and at high speed. Advantageously, the fluid handling device requires only a small amount of reagents and samples for the analysis, and is expected to be used in various applications such as clinical tests, food tests, and environmental tests.

Here, the fluid handling device and another device may be connected to each other for collecting only a specific substance from the fluid handling device or for taking out a substance in the fluid handling device for use in another analysis or reaction. For example, Patent Literature (hereinafter, referred to as “PTL”) 1 describes a fluid handling device in which one end portion of a flexible tube is inserted into a channel substrate (PTL 1). In the fluid handling device, by connecting the other end portion of the tube to the other device, the fluid in the channel substrate can be supplied to a various device side.

### CITATION LIST

### Patent Literature

### PTL 1

### U.S. Patent Application Publication No. 2009/0026082

### SUMMARY OF INVENTION

### Technical Problem

However, in case that only one end portion of the tube is fixed to the channel substrate as in PTL 1, the orientation and height of the tube cannot be fixed and, thus, accurate alignment with various devices is difficult. In addition, when there are a plurality of tubes or connection ports, incorrect attachment or the like may occur. Further, it is difficult to fix the position of the tube even after connecting the channel substrate to the various devices. Accordingly, it may happen that the tube comes off the channel substrate or the other device, or the tube interferes with the other device.

It is an object of the present invention to provide a fluid handling device which can be connected to various devices reliably and easily, and which can supply fluid to and receive fluid from the various devices.

### Solution to Problem

The present invention provides the following fluid handling device:

A fluid handling device, including: a first device including a channel for allowing a fluid to flow therethrough, and an opening portion communicating between the channel and an outside; and a tube that is, at a first end portion, inserted into the opening portion, in which the first device further includes a supporting portion for fixing the tube such that a central axis of a second end portion of the tube has an angle with respect to a central axis of the first end portion of the tube.

### Advantageous Effects of Invention

According to the fluid handling device of the present invention, it is possible to reliably and easily connect the fluid handling device to various devices via a tube, so as to supply fluid to the various devices and receive fluid from the various devices.

### BRIEF DESCRIPTION OF DRAWINGS

FIG. 1 is a perspective view of a fluid handling device according to Embodiment 1 of the present invention;

FIG. 2A is a plan view of the fluid handling device illustrated in FIG. 1;

FIG. 2B is a front view of the fluid handling device;

FIG. 2C is a sectional view taken along line A-A in FIG. 2A;

FIG. 3 is a sectional view of a fluid handling device according to a variation of Embodiment 1;

FIG. 4A is a perspective view of a fluid handling device according to a further variation of Embodiment 1;

FIG. 4B is a front view of the fluid handling device illustrated in FIG. 4A;

FIG. 5A is a perspective view of a fluid handling device according to a further variation of Embodiment 1;

FIG. 5B is a sectional view of the fluid handling device illustrated in FIG. 5A;

FIG. 6 is a perspective view of a fluid handling device according to Embodiment 2 of the present invention;

FIG. 7A is a plan view of the fluid handling device illustrated in FIG. 6;

FIG. 7B is a front view of the fluid handling device;

FIG. 7C is a sectional view taken along line A-A in FIG. 7A;

FIG. 8A is a perspective view of a fluid handling device according to a variation of Embodiment 2; and

FIG. 8B is a sectional view of the fluid handling device illustrated in FIG. 8A.

### DESCRIPTION OF EMBODIMENTS

A fluid handling device of the present invention includes a first device for allowing a fluid to flow therethrough, and a tube connected at a first end portion to a channel of the first device. A second end portion of the tube of the fluid handling device is connected to a second device, such as a detection device or a reaction device, and thus, the fluid in the first device can be supplied to the second device or the fluid in the second device can be received by the first device side. Note that, in the following description, a case in which the fluid in the first device is supplied to the second device will be described as an example, but the present invention is not limited to the above aspect.

Note that, the term “fluid” as used herein is a gas, a liquid, or the like having fluidity, and may contain a single component, or may contain a plurality of components. Further, the fluid may be a solid component dispersed in a solvent or the like. Further, the fluid may also be a droplet or the like dispersed in the solvent, the droplet being not compatible with the solvent. Hereinafter, the fluid handling device of the present invention will be described in detail with reference to the drawings.

### Embodiment 1

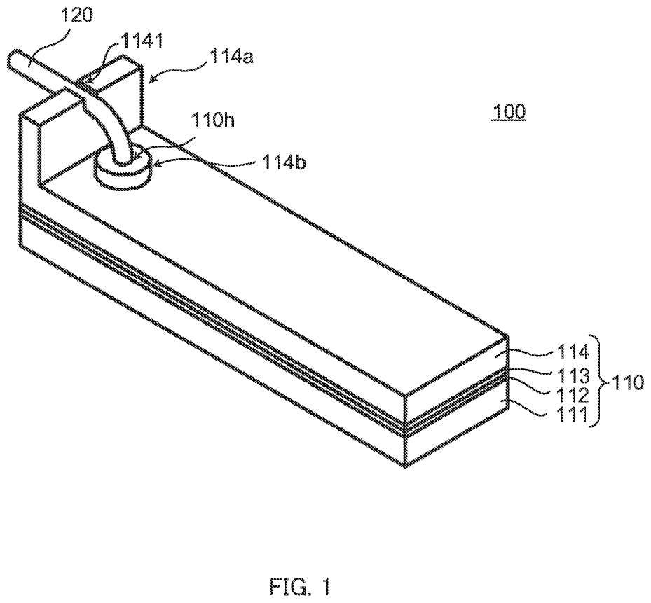

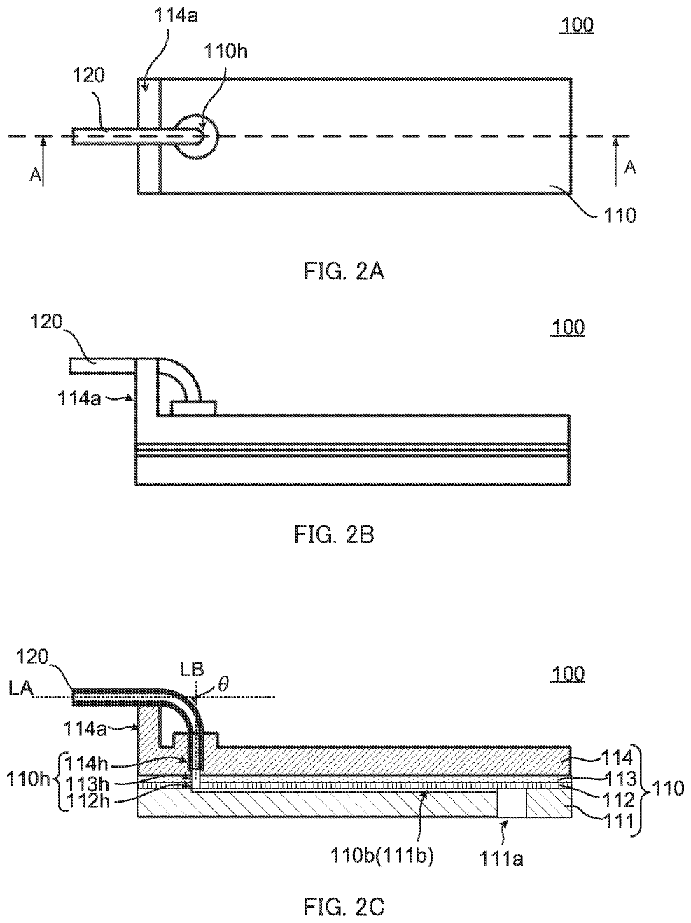

FIG. 1 is a perspective view of fluid handling device 100 according to Embodiment 1. FIG. 2A illustrates a plan view of fluid handling device 100, FIG. 2B illustrates a front view of fluid handling device 100, and FIG. 2C illustrates a sectional view taken along line A-A in FIG. 2A. However, these figures schematically illustrate one example of the structure of fluid handling device 100 of the present embodiment, and fluid handling device 100 is not limited to such a structure.

As illustrated in FIG. 1, fluid handling device 100 of the present embodiment includes first device 110 and tube 120, and the first end portion of tube 120 is inserted into opening portion 110h in first device 110. On the other hand, the second end portion side of tube 120 is fixed by supporting portion 114a of first device 110.

First Device

First device 110 in the present embodiment has a structure in which first substrate 111, film 112, adhesive layer 113, and second substrate 114 are stacked on one another in this order. As illustrated in FIG. 2C, first device 110 in the present embodiment includes inlet 111a for introducing a fluid, channel 110b communicating with inlet 111a for allowing the fluid to flow, opening portion 110h communicating between channel 110b and the outside, and supporting portion 114a supporting the second end portion of tube 120.

In the present embodiment, inlet 111a for introducing a fluid into first device 110 is disposed in the first substrate 111 side. However, the position of inlet 111a is not limited to the first substrate 111 side, and may be disposed in the second substrate 114 side. In addition, in the present embodiment, inlet 111a is opened in a cylindrical shape, but inlet 111a may have a structure conforming to the shape of a syringe, a tube, or the like for introducing a fluid. In addition, first device 110 may have only one inlet 111a or may have two or more inlets.

Channel 110b for allowing a fluid to flow therethrough is defined by a region delimited by film 112 and groove 111b formed in first substrate 111. Channel 110b may be any channel as long as it links inlet 111a to opening portion 110h, and allows a fluid to flow from the inlet 111a side to the opening portion 110h side. Although FIG. 2C illustrates channel 110b that linearly links inlet 111a and opening portion 110h, channel 110b is not limited to the linear structure, and may branch in the middle. Further, first device 110 may include a plurality of channels 110b, and may include a chamber (not illustrated) or the like between channels 110b, the chamber being for temporarily containing a fluid. The chamber may be a region delimited by film 112 and a recess formed in first substrate 111. When the chamber is disposed in first device 110, it becomes possible to perform various kinds of processing on the fluid, such as observing the fluid in the chamber or reacting a component in the fluid with a reagent or the like.

Note that the widths and depths of channel 110b and the chamber are appropriately selected in accordance with the type, flow rate, and the like of the fluid. For example, the widths and depths of channel 110b and the chamber may be uniform or may vary from the inlet 111a side to the opening portion 110h side.

In addition, opening portion 110h may be any portion as long as it can communicates between channel 100b and the outside of first device 110, and includes through holes 112h, 113h, and 114h formed respectively in film 112, adhesive layer 113, and second substrate 114. Although only one opening portion 110h is disposed in first device 110 of the present embodiment, a plurality of opening portions 110h may be disposed in first device 110.

The shape of opening portion 110h is appropriately selected in accordance with the diameter, shape, and the like of the first end portion of tube 120 to be inserted into opening portion 110h. The opening diameter of opening portion 110h may be constant from the second substrate 114 side to the film 112 side, or may change continuously or stepwise. When the first end portion of tube 120 is inserted into opening portion 110h, tube 120 may be inserted to reach the inside of through hole 112h of film 112, or as illustrated in FIG. 2C, tube 120 may be inserted through only a part of opening portion 110h (through only through hole 114h in second substrate 114 in the present embodiment).

When tube 120 is inserted into opening portion 110h, it is preferable that the side wall of opening portion 110h and the outer circumferential surface of tube 120 be brought into close contact with each other, and in first device 110 of the present embodiment, it is preferable that the opening diameter of through hole 114h in second substrate 114 be equal to or smaller than the outer diameter of tube 120.

Here, first device 110 may have a structure for holding the shape of tube 120 inserted into opening portion 110h or fixing the position of tube 120. In the present embodiment, cylindrical holding portion 114b disposed to surround the opening end of opening portion 110h is disposed on second substrate 114. When holding portion 114b is disposed on second substrate 114, deformation and collapse of tube 120 in the vicinity of opening portion 110h are suppressed. Further, in case that holding portion 114b is disposed, the contact area between the wall surface of opening portion 110h and the outer circumferential surface of tube 120 is large. Thus, it becomes unlikely for tube 120 to be detached from opening portion 110h.

In addition, supporting portion 114a for supporting the second end portion side of tube 120 is disposed on second substrate 114. Supporting portion 114a fixes the second end portion side of tube 120 such that the central axis (“LB” in FIG. 2C) of the first end portion of tube 120 fixed to opening portion 110h and the central axis (“LA” in FIG. 2C) of tube 120 on the side connected to the second device (the central axis of the second end portion) have an angle with respect to each other. In the present specification, the term “having an angle” means forming an angle having an absolute value of less than 180°. In the present embodiment, as illustrated in FIG. 2C, angle θ formed by central axis LB of the first end portion of tube 120 and central axis LB of the second end portion of tube 120 is approximately 90°, but is not limited to this angle. However, it is preferable that the absolute value of 0 be about 0 to 175°, and more preferably about 0 to 120°.

In the present embodiment, only one supporting portion 114a is disposed on first device 110, but two or more supporting portions 114a may be disposed on first device 110. For example, a plurality of supporting portions 114a may be disposed along tube 120 such that one tube 120 is supported by a plurality of supporting portions 114a. When there are a plurality of opening portions 110h and a plurality of tubes 120, supporting portions 114a may be disposed so as to support tubes 120, respectively.

Here, the position of supporting portion 114a may be any position as long as it does not hinder the connection between the second device and tube 120, but it is preferable that supporting portion 114a be disposed in a region close to the second end portion of tube 120. In the present embodiment, supporting portion 114a is disposed along the outer edge of first device 110.

The shape of supporting portion 114a only needs to be such that the second end portion of tube 120 can be fixed at a desired height and orientation. Supporting portion 114a of the present embodiment is a rectangular parallelepiped-shaped region protruding in a direction substantially perpendicular to the bonding surface between second substrate 114 and adhesive layer 113. U-shaped notch (groove) 1141 for fixing the second end portion side of tube 120 is formed in the upper portion of supporting portion 114a. The position of the second end portion of tube 120 is fixed by fitting tube 120 into this notch 1141. However, the shape of supporting portion 114a is not limited to this shape.

Here, in the present embodiment, the shape of notch (groove) 1141 that supporting portion 114a has is U-shaped, but the shape of notch 1141 may be any shape as long as it can fix the end portion of tube 120 and does not close tube 120, and the shape of the notch may be, for example, a semicircular shape, a V shape, or the like. However, the depth of the notch is preferably greater than the outer diameter of tube 120. When the depth of notch 1141 is sufficiently deep, tube 120 does not protrude beyond the top surface of supporting portion 114a, and tube 120 fixed to supporting portion 114a can be prevented from interfering with other members to cause closure or a shift in the positions thereof.

The width of notch (groove) 1141 is preferably the same as or slightly smaller than the outer diameter of tube 120. With such a width, the second end portion side of tube 120 fits into the notch, and the position of the second end portion of tube 120 is easily fixed.

Here, first substrate 111 in first device 110 described above only needs to have a through hole forming above-described inlet 111a and groove 111b forming a part of the inner wall of the above-described channel. Examples of the material forming such a first substrate 111 include resin materials such as: polyesters such as polyethylene terephthalate;

polycarbonate; acrylic resins such as polymethylmethacrylate; polyvinyl chloride; polyolefins such as polyethylene, polypropylene, and cycloolefin resins; polyethers; polystyrene; silicone resins; and various elastomers. Above-described first substrate 111 may be formed by, for example, injection molding or the like.

Note that first substrate 111 may be optically transparent or does not have to be optically transparent. For example, in the case where the fluid is observed from the first substrate 111 side after the fluid is introduced into fluid handling device 100, it is preferable to select a material such that first substrate 111 is optically transparent.

Film 112 in first device 110 may be any film as long as it can cover inlet 111a and groove 111b in first substrate 111 and the peripheries thereof and has above-described through hole 112h. In the present embodiment, film 112 is disposed so as to cover one surface of first substrate 111 substantially entirely, but may cover only a partial region of first substrate 111.

Film 112 only needs to be a film made of a material which is not to be eroded by the fluid introduced into fluid handling device 100, and the thickness and the like thereof are appropriately selected. Examples of the material forming film 112 include resin materials such as: polyesters such as polyethylene terephthalate; polycarbonate; acrylic resins such as polymethylmethacrylate; polyvinyl chloride; polyolefins such as polyethylene, polypropylene, and cycloolefin resins; polyethers; polystyrene; silicone resins; and various elastomers.

Further, it is preferable that film 112 and first substrate 111 be bonded together, and they are preferably bonded together by, for example, fusion or an adhesive.

Adhesive layer 113 in first device 110 may be any layer as long as it is capable of bonding film 112 to below-described second substrate 114 and has through hole 113h in a desired region. In the present embodiment, adhesive layer 113 is disposed substantially entirely between film 112 and second substrate 114, but may be disposed only in a partial region.

Note that adhesive layer 113 may be made of an elastic material. In case that adhesive layer 113 is elastic, adhesive layer 113 easily adheres to the outer circumference of tube 120 when the first end portion of tube 120 is inserted into through hole 113h of adhesive layer 113. It is thus possible to prevent the fluid from leaking from a gap between opening portion 110h in first device 110 and tube 120.

Note that adhesive layer 113 may be a layer formed from a freestanding sheet; a film obtained by applying an adhesive, for example, to at least one of film 112 and second substrate 114; or the like. Further, the thickness of adhesive layer 113 is not particularly limited as long as film 112 can be sufficiently adhered to second substrate 114, and is appropriately selected according to the type of adhesive layer 113, the required adhesive strength, and the like. The type of adhesive layer 113 is not particularly limited and may be a layer made of a known adhesive. Examples of the adhesive include vinyl acetate resins; ethylene vinyl acetate resins; epoxy resins; cyanoacrylate resins; acrylic resins; rubbers such as chloroprene rubber, styrene butadiene rubber, fluororubber, silicone rubber, nitrile rubber, ethylene rubber, butylene rubber, and the like; fluororesins such as polytetrafluoroethylene, polychlorotrifluoroethylene, polyvinylidene fluoride, polyvinyl fluoride, and the like; and the like.

Second substrate 114 in first device 110 is a plate-like member disposed on adhesive layer 113, and only needs to have supporting portion 114a and holding portion 114b on the surface of the second substrate opposite to adhesive layer 113. The surface of second substrate 114 facing adhesive layer 113 may have a flat plate shape or may be roughened. Second substrate 114 may cover the entire surfaces of first substrate 111 and/or film 112, or may cover only a partial region of the surfaces.

The material of second substrate 114 may be the same as the material of first substrate 111. Second substrate 114 may be integrally molded by injection molding or the like, or may be formed by separately fabricating a flat plate-shaped member, supporting portion 114a, and holding portion 114b, and bonding them to one another.

Tube 120

Tube 120 only needs to be a cylindrical member connectable to opening portion 110h in first device 110 and a connection port of the second device, and may be flexible or does not have to be flexible. Further, the material of the tube is not particularly limited as long as it is a material which is not to be eroded by a fluid, and may be made of metal or may be made of resin. The inner diameter of the tube is appropriately selected according to the type of fluid and the like. The outer diameter of tube 120 is appropriately selected in accordance with the application of the fluid handling device, the strength of tube 120, and the like. The inner diameter and the outer diameter of tube 120 may be uniform or different between the first end portion inserted into opening portion 110h in first device 110 and the second end portion connected to the second device.

In the present embodiment, tube 120 is configured to be detachable from opening portion 110h in first device 110, but tube 120 may be joined to opening portion 110h in first device 110.

Fluid Handling Method

When using fluid handling device 100 described above, the first end portion of tube 120 of fluid handling device 100 is inserted into opening portion 110h in first device 110. On the other hand, the second end portion side of tube 120 is fitted into notch 1141 in supporting portion 114a of first device 110. Tube 120 is fixed at two points. Fluid handling device 100 is then placed near a desired second device (not illustrated) and the second end portion of tube 120 is connected to the connection port of the second device.

Then, a desired fluid is introduced through inlet 111a of first device 110 and is allowed to flow through channel 110b. At this time, the fluid may be observed as necessary. Further, it may be possible that fluids flowing in first device 110 are sorted, and only a desired fluid is moved to channel 110b connected to opening portion 110h (tube 120).

Then, the fluid reaching the vicinity of opening portion 110h in first device 110 is moved to the second device side via tube 120. During the movement, the fluid may be sucked from the device side, or the fluid may be pushed out by applying pressure from the inlet 111a side of fluid handling device 100. Also, the orientation of fluid handling device 100 may be adjusted such that the first end portion of the tube (the end portion connected to first device 110) is on the upper side in the gravity direction, and the second end portion of the tube (the end portion connected to the second device) is on the lower side in the gravity direction. In this case, gravity facilitates the movement of the fluid within tube 120, making it easier to move the fluid to the second device.

Other

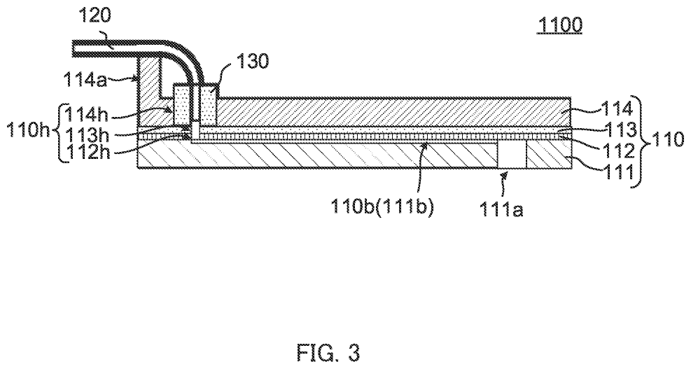

In above-described fluid handling device 100, holding portion 114b is disposed on second substrate 114, but for example, as illustrated in FIG. 3, cylindrical elastic sealing member 130 may be disposed inside opening portion 110h in first device 110. FIG. 3 is a sectional view of fluid handling device 1100 according to a variation of the present embodiment. Since fluid handling device 1100 illustrated in FIG. 3 is the same as fluid handling device 100 described above except for sealing member 130, the same members between the embodiment and the variation are denoted by the same reference numerals, and a detailed description thereof is omitted.

As illustrated in FIG. 3, by fitting cylindrical sealing member 130 into opening portion 110h and inserting tube 120 into sealing member 130, it becomes unlikely that a gap is formed between sealing member 130 and tube 120 and between the wall surfaces of sealing member 130 and opening portion 110h. Accordingly, it becomes unlikely for the first end portion of tube 120 to come off opening portion 110h (sealing member 130), and leakage of fluid is suppressed. In this case, the opening diameter of opening portion 110h is preferably set slightly smaller than the outer diameter of sealing member 130.

Examples of the material constituting such a sealing member 130 include the same materials as the resins and the like constituting adhesive layer 113 described above.

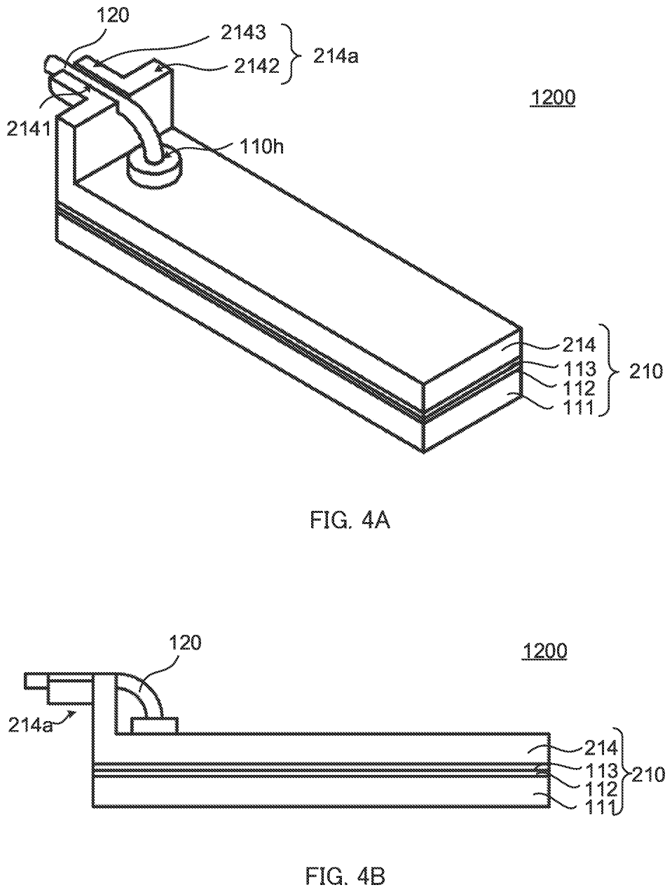

The shape of supporting portion 114a of second substrate 114 of fluid handling device 100 described above is not limited to a substantially rectangular parallelepiped shape, and the supporting portion may include, for example, plate-shaped portion 2142 protruding in a direction substantially perpendicular to the bonding surface between second substrate 214 and adhesive layer 113, and protruding portion 2143 protruding from plate-shaped portion 2142 radially outward (on the second end portion side of tube 120) with respect to fluid handling device 1200, as illustrated in FIGS. 4A and 4B. Groove-shaped notch 2141 in which tube 120 can be fitted is formed in plate-like portion 2142 and protruding portion 2143.

Note that FIG. 4A is a perspective view of fluid handling device 1200 according to a variation of the present embodiment, and FIG. 4B is a front view of fluid handling device 1200. Since fluid handling device 1200 illustrated in FIGS. 4A and 4B is the same as fluid handling device 100 described above except for the shape of supporting portion 214a of second substrate 214 of first device 210, the same members between the embodiment and the variation are denoted by the same reference numerals, and detailed descriptions thereof are omitted.

According to supporting portion 214a in fluid handling device 1200 of the variation, the contact area between supporting portion 214a and tube 120 can be increased, and it thus becomes more unlikely for the second end portion of tube 120 to move. Also in this variation, the shape of notch 2141 (groove) that supporting portion 214a has is U-shaped, but the shape of the notch is not limited to this shape.

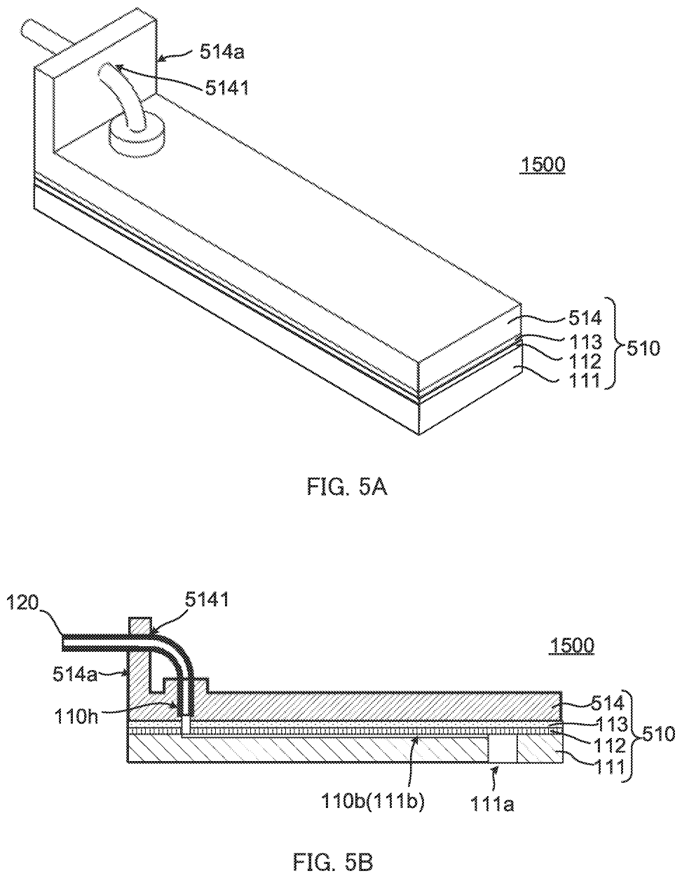

In addition, fluid handling device 1500 according to a further variation of the present embodiment is illustrated in FIGS. 5A and 5B. FIG. 5A is a perspective view of fluid handling device 1500 according to the variation, and FIG. 5B is a sectional view of fluid handling device 1500. Since fluid handling device 1500 illustrated in FIGS. 5A and 5B is the same as fluid handling device 100 described above except for the shape of supporting portion 514a of second substrate 514 of first device 510, the same members between the embodiment and the variation are denoted by the same reference numerals, and detailed descriptions thereof are omitted.

In fluid handling device 1500 according to the variation, supporting portion 514a of second substrate 514 has second through hole 5141. The diameter of second through hole 5141 is preferably the same as or slightly smaller than the outer diameter of tube 120. In case that supporting portion 514a has second through hole 5141, the outer circumference of tube 120 can be supported by second through hole 5141, and the second end portion of tube 120 can be easily fixed.

Above-described fluid handling device 100 may further include a stopper (not illustrated) for fixation between supporting portion 114a and tube 120. The stopper may be an annular member that is fixed to one, two, or more portions of the outer circumference of tube 120 and protrudes radially outward from tube 120. In this case, the movement of tube 120 is suppressed when supporting portion 114a comes into contact with the stopper.

Further, in the above-described fluid handling device, an elastic body (not illustrated) or the like may be disposed on the inner circumference of notch 1141 in supporting portion 114a. In case that the elastic body is disposed on the inner circumference of notch 1141, a frictional force is generated between tube 120 and the elastic body, and therefore, the position of tube 120 is unlikely to be shifted.

### Embodiment 2

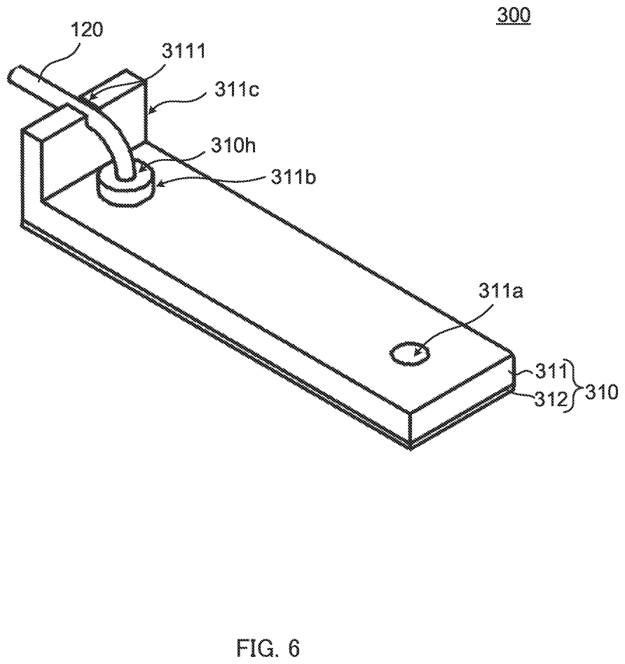

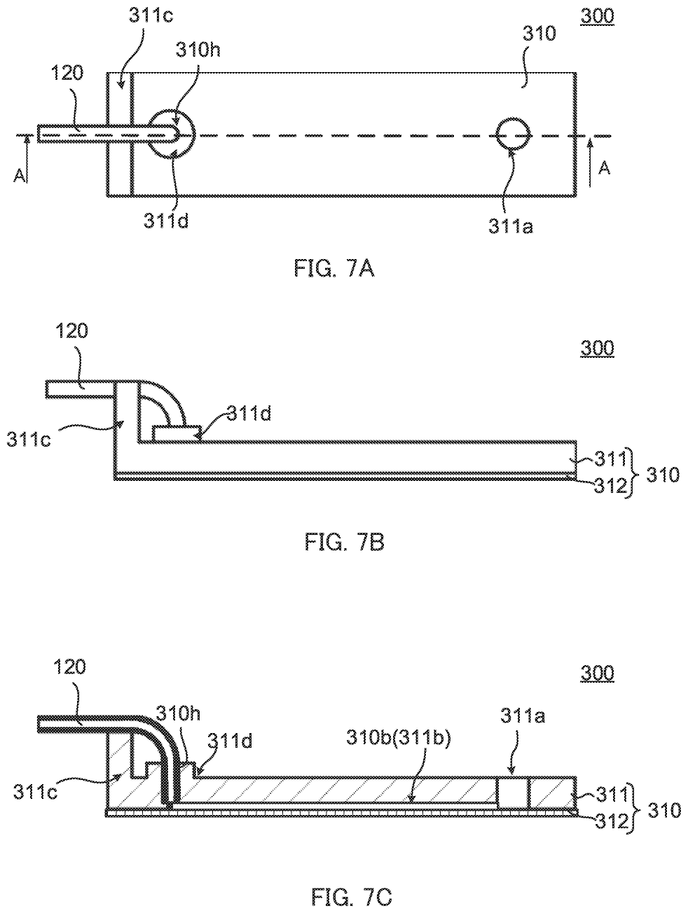

FIG. 6 is a perspective view of fluid handling device 300 of Embodiment 2. FIG. 7A illustrates a plan view of fluid handling device 300, FIG. 7B illustrates a side view of fluid handling device 300, and FIG. 7C illustrates a sectional view taken along line A-A in FIG. 7A. Note that, these figures schematically illustrate one example of the structure of fluid handling device 300 of the present embodiment, and fluid handling device 300 is not limited to this structure.

Fluid handling device 300 of Embodiment 2 includes first device 310 and tube 120. In fluid handling device 300, the first end portion of tube 120 is fixed to opening portion 310h in first device 310, and the second end portion of tube 120 is fixed by supporting portion 311c of first device 110. Tube 120 of fluid handling device 300 of the present embodiment is the same as tube 120 of fluid handling device 100 of Embodiment 1 described above. Therefore, only first device 310 will be described below.

First device 310 of the present embodiment has a structure in which main body portion 311 and film 312 are stacked on each other. In addition, first device 310 of the present embodiment has inlet 311a for introducing a fluid, channel 310b communicating with inlet 311a and allowing the fluid to flow therethrough, opening portion 310h communicating between channel 310b and the outside, and supporting portion 311c supporting the second end portion side of tube 120.

In the present embodiment, inlet 311a for introducing a fluid is disposed in main body portion 311. However, inlet 311a may be disposed in the film 312 side. Further, first device 310 may have only one inlet 311a or two or more inlets 311a.

Further, channel 310b for allowing the fluid to flow therethrough is a region delimited by groove 311b formed in main body portion 311 and film 312. Channel 310b may be any channel as long as it links inlet 311a to opening portion 310h, and allows a fluid to flow from the inlet 311a side to the opening portion 310h side. Although FIG. 7C illustrates channel 310b that linearly links inlet 311a and opening portion 310h, channel 310b is not limited to the linear structure, and may branch in the middle. Further, first device 310 may include a plurality of channels 310b, and may include a chamber (not illustrated) or the like between channels 310b, the chamber being for temporarily containing a fluid. The shapes of channel 310b and the chamber may be the same as the shapes of channel 110b and the chamber of first device 110 of Embodiment 1.

In addition, opening portion 310h into which the first end portion of tube 120 is inserted is formed by a through hole formed in main body portion 311. Although first device 310 of the present embodiment has only one opening portion 310h, first device 310 may have a plurality of opening portions 310h. The shape of opening portion 310h may be the same as the shape of opening portion 110h in first device 310 of Embodiment 1.

Also in the present embodiment, first device 310 may have a structure for holding the shape of tube 120 inserted into opening portion 310h or fixing the position of tube 120. In the present embodiment, holding portion 311d disposed to surround the opening end of opening portion 310h is disposed on main body portion 311. In case that holding portion 311d is disposed on main body portion 311, holding portion 311d supports the outer circumferential surface of tube 120, and deformation and collapse of tube 120 are suppressed. In addition, since the contact area between opening portion 310h and the outer circumferential surface of tube 120 is enlarged, tube 120 becomes unlikely to be detached from opening portion 310h.

In addition, supporting portion 311c supporting the second end portion side of tube 120 only needs to be configured to fix the second end portion side of tube 120 such that the central axis of the first end portion of tube 120 fixed to above-described opening portion 310h and the central axis of the second end portion connected to the second device of tube 120 have an angle with respect to each other.

In the present embodiment, first device 310 has only one supporting portion 311c, but first device 310 may have two or more supporting portions 311c. For example, a plurality of supporting portions 311c may be disposed along tube 120 such that one tube 120 is supported by a plurality of supporting portions 311c. When there are a plurality of opening portions 310h and a plurality of tubes 120, supporting portions 311c may be disposed so as to support tubes 120, respectively.

Here, the position of supporting portion 311c is not particularly limited and may be any position as long as it does not hinder the connection between the second device and tube 120. It is preferable that supporting portion 311c be disposed in a region close to the second end portion of tube 120. In the present embodiment, supporting portion 311c is disposed along the outer edge of first device 310.

The shape of supporting portion 311c only needs to be such that the second end portion of tube 120 can be fixed at a desired height and orientation. Supporting portion 311c of the present embodiment is a rectangular parallelepiped-shaped region protruding in a direction substantially perpendicular to the bonding surface between main body portion 311 and film 312. U-shaped notch (groove) 3111 for fixing tube 120 is formed in the upper portion of supporting portion 311c. The position of the second end portion of tube 120 is fixed by fitting tube 120 into this notch 3111. However, the shape of supporting portion 311c is not limited to this shape.

Here, the material constituting main body portion 311 is the same as the material constituting first substrate 111 of Embodiment 1 described above. Further, main body portion 311 may be optically transparent or does not have to be optically transparent. For example, in case that a fluid is observed from the main body portion 311 side of fluid handling device 300, it is preferable to select a material such that main body portion 311 is optically transparent.

In addition, film 312 only needs to be a film that can cover groove 311b in main body portion 311. In the present embodiment, film 312 is disposed so as to cover one surface of main body portion 311 substantially entirely, but may be disposed so as to cover only a partial region of main body portion 311, for example. This film 312 is made of the same material as film 112 of Embodiment 1 described above.

Further, film 312 may be or does not have to be optically transparent. For example, in case that the fluid is to be observed from the film 312 side, it is preferable to select the material such that film 312 is optically transparent. However, in case that the fluid is to be observed from the main body portion 311 side of fluid handling device 300, or in case that the fluid is not observed, film 312 does not have to be optically transparent.

Fluid Handling Method

When using fluid handling device 300 described above, the first end portion of tube 120 of fluid handling device 300 is inserted into opening portion 310h in first device 310.

On the other hand, the second end portion side of tube 120 is fitted into notch 3111 in supporting portion 311c of first device 310. Tube 120 is fixed at two points. Fluid handling device 300 is then placed near a desired second device (not illustrated) and the second end portion of tube 120 is connected to the connection port of the second device.

Then, a desired fluid is introduced through inlet 311a of first device 310 and is allowed to flow through channel 310b. At this time, the fluid may be observed as necessary. Further, it may be possible that fluids flowing in first device 310 are sorted, and only a desired fluid is moved to channel 310b connected to opening portion 310h (tube 120).

Then, the fluid reaching the vicinity of opening portion 310h in first device 310 is moved to the device side via tube 120. During the movement, the fluid may be sucked from the device side, or the fluid may be pushed out by applying pressure from the inlet 311a side of fluid handling device 300. Also, the orientation of fluid handling device 300 may be adjusted such that the first end portion of the tube (the end portion connected to first device 310) is on the upper side in the gravity direction, and the second end portion of the tube (the end portion connected to the second device) is on the lower side in the gravity direction. In this case, gravity facilitates the movement of the fluid within tube 120, making it easier to move the fluid to the second device.

Other

Also in the present embodiment, a cylindrical elastic sealing member (not illustrated) may be disposed instead of holding portion 311d that main body portion 311 has. By fitting the cylindrical sealing member into opening portion 310h and inserting tube 120 into the sealing member, it becomes unlikely that a gap is formed between the sealing member and tube 120 and between the sealing member and the wall surface of opening portion 310h. Accordingly, it becomes unlikely for tube 120 to come off, and leakage of fluid is suppressed. In this case, the opening diameter of opening portion 310h is preferably set slightly smaller than the outer diameter of the sealing member. The sealing member may be the same as that described for Embodiment 1.

Further, the shape of supporting portion 311c is also not limited to the above-described shape, and for example, the shape of main body portion 311 of the present embodiment may be constructed the same as that of second substrate 214 of the first device illustrated in FIG. 4A. That is, supporting portion 311c may have such a shape as that illustrated in FIGS. 4A and 4B in which the supporting portion has plate-like portion 2142 and protruding portion 2143 protruding from plate-like portion 2142 radially outward (on the second end portion side of tube 120) with respect to the fluid handling device (denoted by “1200” in FIGS. 4A and 4B).

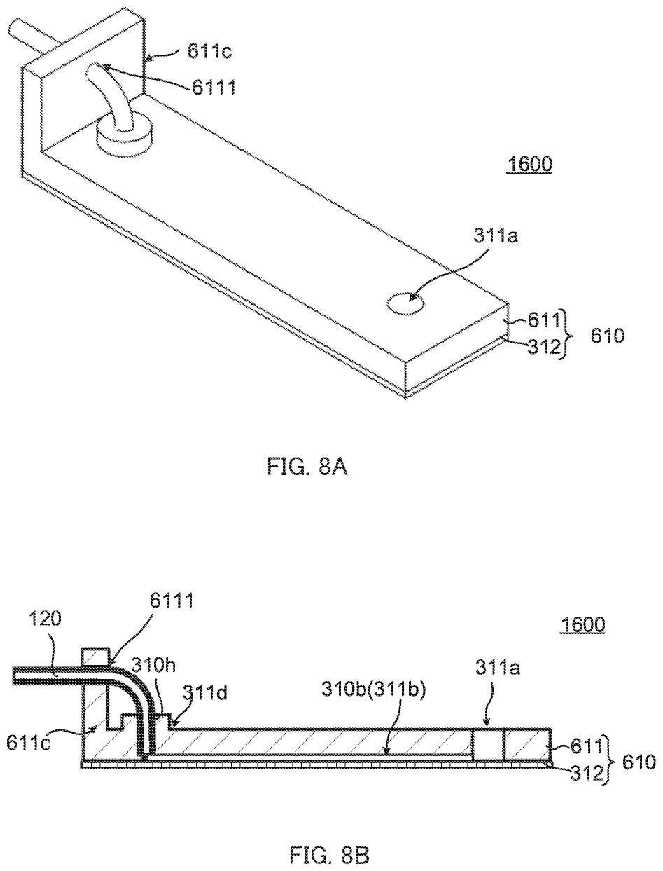

Fluid handling device 1600 according to a further variation of the present embodiment is illustrated in FIGS. 8A and 8B. FIG. 8A is a perspective view of fluid handling device 1600 according to the variation, and FIG. 8B is a sectional view of fluid handling device 1600. Note that fluid handling device 1600 illustrated in FIG. 8A and FIG. 8B is the same as fluid handling device 300 described above except for the shape of supporting portion 611c of main body portion 611 of first device 610. The same members are denoted by the same reference numerals, and a detailed description thereof is omitted.

In fluid handling device 1600 according to the variation, supporting portion 611c of main body portion 611 has second through hole 6111. The diameter of second through hole 6111 is preferably the same as or slightly smaller than the outer diameter of tube 120. In case that supporting portion 611c has second through hole 6111, the outer circumference of tube 120 can be supported by supporting portion 611c, and the second end portion of tube 120 is easily fixed.

In addition, above-described fluid handling device 100 may further include a stopper (not illustrated) for fixation between supporting portion 311c and tube 120, or an elastic body (not illustrated) may be disposed on the inner circumference of the notch in supporting portion 311c.

(Effect)

According to the fluid handling device of the present invention, the tube is fixed at two positions by the first device in all of the embodiments. Thus, connection to the second device is facilitated. Further, the tube is unlikely to move after the tube is attached to the first device. Thus, the tube is unlikely to be caught by another member and damaged, to come off the first device or the second device, and to interfere with a detection device or the like.

The present patent application claims the benefit of priority based on Japanese Patent Application No. 2019-208874 filed on Nov. 19, 2019. The disclosure of the specification, drawings and abstract of the Japanese Patent Application is incorporated in the specification of the present application by reference in its entirety.

### INDUSTRIAL APPLICABILITY

The fluid handling device of the present invention can be easily and accurately connected to various devices. Therefore, it is particularly useful as a microfluidic handling device or the like used for various tests and analyses.

### REFERENCE SIGNS LIST

100, 300, 1100, 1200, 1500, 1600 Fluid handling device
110, 210, 310, 510, 610 First device
110b, 310b Channel
110h, 310h Opening portion
111 First substrate
111a, 311a Inlet
111b, 311b Groove
112, 312 Film
112h, 113h, 114h Through hole
113 Adhesive layer
114, 214, 514 Second substrate
114a, 214a, 311c, 514a, 611c Supporting portion
114b, 311d Holding portion
120 Tube
130 Sealing member
311, 611 Main body portion
1141, 2141, 3111 Notch
2142 Plate-like member
2143 Protruding portion
5141, 6111 Second through hole
LA Central axis of second end portion of tube
LB Central axis of first end portion of tube
θ Angle formed by central axis of second end portion of tube and first central axis

1. A fluid handling device, comprising:
a first device including a channel for allowing a fluid to flow therethrough, and an opening portion communicating between the channel and an outside; and
a tube that is, at a first end portion, inserted into the opening portion, wherein
the first device further includes a supporting portion for fixing the tube such that a central axis of a second end portion of the tube has an angle with respect to a central axis of the first end portion of the tube.

2. The fluid handling device according to claim 1, wherein the tube is flexible.

3. The fluid handling device according to claim 1, wherein the tube is made of metal.

4. The fluid handling device according to claim 1, wherein
the supporting portion includes a notch or a through hole and the tube is fitted into the notch or the through hole.

5. The fluid handling device according to claim 1, wherein:
the first device includes:
a first substrate including a groove forming a part of an inner wall of the channel,
a film disposed to cover the groove in the first substrate,
an adhesive layer disposed on the film, and
a second substrate disposed on the adhesive layer and having the supporting portion on a surface of the second substrate opposite to the adhesive layer, and
each of the film, the adhesive layer, and the second substrate has a through hole forming the opening portion.

6. The fluid handling device according to claim 1, wherein
the first device includes:
a main body portion including:
a groove forming a part of an inner wall of the channel,
a through hole connected to the groove and forming the opening portion, and
a supporting portion disposed on a surface of the main body portion opposite to the groove, and
a film covering the groove in the main body portion.

7. The fluid handling device according to claim 1, further comprising:
a cylindrical elastic sealing member fitted into the opening portion, wherein
the first end portion of the tube is inserted into the sealing member.
